(19) United States
(12) Patent Application Publication
(10) Pub. No.: US 2022/0176330 A1
(43) Pub. Date: Jun. 9, 2022

(54) DYNAMIC MIXER, DISPENSING ASSEMBLY AND METHOD OF DISPENSING MULTI-COMPONENT MATERIAL FROM A CARTRIDGE

(71) Applicant: Sulzer Mixpac AG, Haag (CH)

(72) Inventors: Samira JAFARI, Zürich (CH); Lorenz SCHENK, Amriswil (CH); Josef MOSER, Haag (CH)

(21) Appl. No.: 17/599,058

(22) PCT Filed: Mar. 27, 2020
(86) PCT No.: PCT/EP2020/058645

§ 371 Date: Sep. 28, 2021

(30) Foreign Application Priority Data
Mar. 29, 2019 (EP) 19166111.5

(51) Int. Cl. B01F 27/272; B01F 35/52; B01F 35/71

(52) U.S. Cl. CPC B01F 27/2721; B01F 27/2722; B01F 27/2723; B01F 2101/2305; B01F 35/7164; B01F 35/7174; B01F 35/522

(57) ABSTRACT

A dynamic mixer has two inlets arranged at an inlet side of the dynamic mixer and an outlet arranged at an outlet side of the dynamic mixer. The mixing element of the dynamic mixer is configured to be coupled to a drive shaft to drive the mixing element about a longitudinal axis of the mixing element.

### CROSS-REFERENCE TO RELATED APPLICATIONS

This application is a U.S. National Stage application of International Application No. PCT/EP2020/058645, filed Mar. 27, 2020, which claims priority to European Patent Application No. 19166111.5, filed Mar. 29, 2019, the contents of each of which are hereby incorporated herein by reference.

### BACKGROUND

### Field of the Invention

Embodiment of the present invention relate to a dynamic mixer having two or more inlets arranged at an inlet side of the dynamic mixer and an outlet arranged at an outlet side of the dynamic mixer, wherein the mixing element of the dynamic mixer is configured to be coupled to a drive shaft to drive the mixing element about a longitudinal axis of the mixing element. Embodiment of the invention further relates to a dispensing assembly comprising a dispenser, a cartridge, optionally filed with a multi-component material, received in the dispenser and a dynamic mixer and to a method of dispensing multi-component material from a cartridge using a dynamic mixer.

### Background Information

Conventional dynamic mixers respectively mixing tips, as they are also known as, are used to mix multi-component material dispensed from a multi-component cartridge. Such conventional mixers are used in a plethora of fields of application ranging from industrial applications, such as the use of adhesives to bond structural components one to another, or as protective coatings for buildings or vehicles, to medical and dental applications, for example, to make dental molds.

The multi-component material is, for example, a two-component adhesive comprising a filler material and a hardener. In order to obtain the best possible mixing result, e.g. an adhesive having the desired bond strength, the multi-component material has to be thoroughly mixed.

For this purpose the dynamic mixers are structured to repeatedly divide and re-combine part flows of the multi-component material to thoroughly mix the multi-component material.

### SUMMARY

It has been found that upon mixing the multi-component material, the material remaining in the dynamic mixer after the dispensing process is generally discarded as it remains in the dynamic mixer. Depending on the field of application the multi-component material can be comparatively expensive and may only be used for one application at a time. This is particularly true, for example in the dental field, where only part of the multi-component material stored in the cartridge is used for one application/patient at a time with the remaining multi-component material being stored in the multi-component cartridge for future applications. Thus, the excessive use of large volumes of multi-component material remaining in a dynamic mixer after a single use leads to unnecessary cost.

For this reason it is an object of embodiments of the present invention to provide a dynamic mixer in which the mixing efficiency is increased, with the mixing efficiency being a balance between low waste volume, low pressure loss, low energy consumption and a good mixing quality. It is a further object of embodiments of the invention to make available a dynamic mixer that can be produced in an as facile manner as possible.

This object is satisfied by a dynamic mixer having the features described herein.

One embodiment is directed to a dynamic mixer that has two or more inlets arranged at an inlet side of the dynamic mixer and an outlet arranged at an outlet side of the dynamic mixer, wherein the mixing element of the dynamic mixer is configured to be coupled via a coupling to a drive shaft to drive the mixing element about a longitudinal axis of the mixing element, wherein the mixing element of the dynamic mixer comprises a rotor body and three, four or more rows of rotor blades arranged one after another and projecting radially from the rotor body away from the longitudinal axis between the rotor body and a housing accommodating the dynamic mixer, wherein the rotor body decreases in size from the inlets towards the outlet at least over 30% of a length of the rotor body, wherein the first of the three, four or more rows of rotor blades is arranged at a different axial position along the longitudinal axis of the mixing element in comparison to the third of the three, four or more rows of rotor blades, wherein three or more rows of stator blades are provided with a respective row of stator blades being arranged in alternating arrangement with the three, four or more rows of rotor blades, wherein each of the inlets is formed by a passage having an inlet opening and a mixer entry opening formed, in particular directly, adjacent to the first row of rotor blades, wherein the respective inlet opening is arranged in parallel to the mixer entry opening, and in parallel to an outlet opening of the outlet, i.e. the inlet opening and the mixer entry opening are arranged at an angle of 90° with respect to the longitudinal axis.

The inlet opening can thus be the opening into the dynamic mixer that is furthest away from the outlet opening and that is arranged at the end of the passage forming the inlet into the dynamic mixer.

The combination rotor-stator-rotor-stator-rotor-stator etc. generates an interruption of the rotating mass moving along the longitudinal axis. This results in a shear stress acting on the mass between the movable rotor blades and the stationary stator blades. This shear stress introduces an intermittent stop into a flow of the multi-component material moving through the dynamic mixer along the longitudinal axis resulting in changes of the flow speed of the respective part flow leading to improved mixing results.

Moreover, the arrangement enables the reduction of a pressure loss in the dynamic mixer which in combination with the improved mixing result considerably increases the mixing efficiency achievable in comparison to prior art dynamic mixers of up to 20%.

By forming the rotor body such that it decreases in diameter over at least a part of its length ensures that the two flow paths of different materials can be gradually combined on traversing the dynamic mixer. Thereby improved mixing results and a reduced waste volume can be achieved.

In this connection it should be noted that such dynamic mixers can be produced in a facile and reproducible manner in an injection molding process and also in a 3D printing process.

In this connection it should be noted that in some embodiments the inlet opening can be arranged inclined with respect to the mixer entry opening at angles of less than 60°, preferably less than 45° with respect to the longitudinal axis, whereas the mixer entry opening is then still arranged at an angle of 90° with respect to the longitudinal axis.

At least one row of the three, four or more rows of rotor blades can be arranged at the part of the rotor body decreasing in size. In this way the flow of material to be mixed can still be rotated while being guided to the outlet such that the multi-component material is continuously mixed while traversing a length of the rotor body.

The rotor body can comprise a conical shaped part arranged at a rear end of the mixing element, wherein the third row of rotor blades can be arranged projecting from the conical shaped part. Such a conical outer shape enables the formation of particularly short flow paths for the multi-component material.

The rotor body can comprise a cylindrical shaped part at its front end, with the first and second row of rotor blades projecting from the cylindrical shaped part. Such a cylindrical shaped part has found to be beneficial with respect to minimizing the volume of air within an empty dynamic mixer and hence the amount of waste material remaining in a dynamic mixer after its use.

Three rows of rotor blades can be provided, with the first and second row of rotor blades comprising the same number of rotor blades and the third row of rotor blades comprising less rotor blades than either of the first and second rows of rotor blades. The reduction in the number of rotor blades at the thinner part of the rotor body ensures a reduction in the size of the flow path of the multi-component material leading to less air volume present in the dynamic mixer in which waste material can be left behind.

In this connection it should be noted that the size of the flow path reduces, in particular continuously reduces between the mixer inlet area and the outlet.

The first and second rows of rotor blades can each comprise between 10 and 20, preferably 14 rotor blades and/or wherein the third row of rotor blades can comprise between 5 and 9, preferably 7 rotor blades. These number of rotor blades have been found to yield particularly beneficial mixing results.

As many rows of stator blades can be provided as rows of rotor blades can be provided, with the alternating arrangement starting at the inlets starting with the first row of rotor blades and with the final row of stator blades being arranged closer to the outlet than the final row of rotor blades. As the rotor blades rotate relative to the inlets a flow of material entering the dynamic mixer can be continuously sliced with the first row of rotor blades in order to introduce a rotational component into the axial flow of the different components. This combined axial and rotational flow of slices of different material of the multi-component material ensures an improved through mixing. By forming the rotor blades directly adjacent to the inlets the complete length of the mixing element can be used for the mixing process.

In this connection it should be noted that two rows of stator blades that are arranged directly adjacent to one another with a gap therebetween can be considered a single row of stator blades provided the height of the two rows of stator blades is less than a height of the adjacent rows of rotor blades.

It should further be noted that two rows of rotor blades that are arranged directly adjacent to one another with a gap therebetween can be considered a single row of rotor blades provided that the height of the two rotor blades arranged directly adjacent to one another does not exceed 400% of a height of a directly adjacent row of stator blades.

Between three and ten, preferably seven, stator blades can be arranged in each row of stator blades. This number of stator blades has been found to be advantageous. The number of stator blades is typically selected to create the best possible shear forces on the rotating multi-component material to achieve beneficial mixing results for this reason the number of stator blades can be equal to or less than the number of rotor blades.

The coupling can be formed at or in the rotor body. By forming the coupling in or at the rotor body the coupling can be integrally produced therewith reducing the number of components of a dynamic mixer.

Four rows of rotor blades can be provided with each row of rotor blades being arranged at a different axial position along the longitudinal axis of the mixing element in comparison to the remaining row of rotor blades. This is a particularly beneficial design having regard to the minimization of waste material left behind in the dynamic mixer.

Two or three of the four rows of rotor blades can comprise the same number of rotor blades. This ensures a thorough through mixing of the multi-component material.

An axial gap along the longitudinal axis between directly adjacent rotor and stator blades can be selected in the range of 0.01 to 0.4 mm, and preferably can be selected as 0.2 mm. A radial gap between an inner surface of the housing and one of the rotor blades and respectively between one of the stator blades and the rotor body can be selected in the range of 0.01 to 0.4 mm, and preferably can be selected as 0.2 mm. These dimensions have been found to produce a favorable introduction of the shear stress into the flow of the multi-component material.

The cross-sectional size of the inlet can increase, in particular continuously increase, between the inlet opening and the mixer entry opening. In this way a particularly good flow of the multi-component material can be achieved in the respective inlet leading to a reduced pressure loss within the dynamic mixer.

Each inlet can have a cross-sectional size and/or shape that can change between the inlet opening and the mixer entry opening, with the inlet opening optionally having a circular shape. By varying the cross-sectional size and/or shape of the inlets, the mixer entry opening can be formed such that it has a shape and size that is ideally suited for forming as uniform as possible slices of multi-component material between two directly adjacent rotor blades to obtain as good as possible mixing results and to reduce the pressure loss within the dynamic mixer.

A variation of the cross-sectional size can in some embodiments be a continuous increase or decrease in size or also a variation between increase and decrease in size over the length of the passage.

A variation in the shape of the cross-section can in some embodiments be a change from a circular cross-section of the passage to that of a ring segment, or from circular to polygonal or the like.

The change in size and/or shape of the respective inlet passage is selected in dependence on a size of the outlet of a corresponding cartridge or the like connected to the inlet of the dynamic mixer and the actual size of the housing and the mixing element arranged within the housing of the dynamic mixer.

An area between two directly adjacent rotor blades of the first row of rotor blades, the rotor body and the housing can be an open area, and wherein the mixer entry opening has a mixer inlet area, with the mixer inlet area being able to be selected greater than the open area.

The mixer inlet area can be the area of the opening of the inlet passage at the end of the passage directly adjacent to the rotor blades. The open area can be the area between two rotor blades that are arranged next to one another, specifically in the region of the mixer inlet area.

By forming the end of the passage of the inlet such that it has a greater area than a space between directly adjacent rotor blades of the first row of rotor blades enables a slice of a flow of material introduced into the dynamic mixer to essentially have a uniform shape and size between directly adjacent rotor blades, so that particularly good mixing results are achievable due to the uniform sizes of the individual slices of multi-component material. The slices are obtained any time a pair of rotor blades of the first row of rotor blades passes the respective mixer entry opening. As the rotor blade rotates further, the slice of the first component is then brought into contact with a slice of the second component of the multi-component material if a two-component material is to be mixed with the dynamic mixer, this process is repeated several times as the mixing element rotates further to mix the respective components.

The mixer inlet area can be less than twice the open area. If the mixer inlet area is selected too large, then more material can be retained in the dynamic mixer which increases the residual waste volume present in the dynamic mixer.

The inlet opening can have an inlet area that is smaller than the mixer inlet area of the mixer entry opening. Different cartridges have different outlet sizes and in order to obtain as good a mixing result as possible it may be beneficial to increase the diameter of the flow of the respective component exiting the multi-component cartridge so that the ideal amount of multi-component material can be made available at the mixer entry opening. Also the tooling required for the production of the inlets can be simplified as the inlets can be easily removed e.g. from an injection mold if they have a shape which reduces in size between two ends of the inlets.

According to a further aspect, the present invention relates to a dispensing assembly comprising a dispenser, a cartridge, optionally filed with a multi-component material, received in the dispenser and a dynamic mixer, wherein the dispenser comprises a drive shaft that can be coupled to the mixing element of the dynamic mixer to drive the mixing element about a longitudinal axis of the mixing element on dispensing the multi-component material from the cartridge.

Using such a dispensing assembly the multi-component material stored in the dynamic mixer can be mixed with particularly advantageous mixing results.

The multi-component cartridge can thus be filled with materials selected from the group of members including topical medications, medical fluids, wound care fluids, cosmetic and/or skin care preparations, dental fluids, veterinary fluids, adhesive fluids, disinfectant fluids, protective fluids, paints and combinations of the foregoing.

Such fluids and hence the dispensing assembly can therefore be expediently used in the treatment of target areas such as the nose (e.g. anti-histaminic creams etc.), ears, teeth (e.g. molds for implants or buccal applications (e.g. aphtas, gum treatment, mouth sores etc.), eyes (e.g. the precise deposition of drugs on eyelids (e.g. chalazion, infection, anti-inflammatory, antibiotics etc.), lips (e.g. herpes), mouth, skin (e.g. anti-fungal, dark spot, acne, warts, psoriasis, skin cancer treatment, tattoo removal drugs, wound healing, scar treatment, stain removal, anti-itch applications etc.), other dermatological applications (e.g. skin nails (for example anti-fungal applications, or strengthening formulas etc.) or cytological applications.

Alternatively the fluids and hence the dispensing assembly can also be used in an industrial sector both for the production of products as well as for the repair and maintenance of existing products, e.g. in the building industry, the automotive industry, the aerospace industry, in the energy sector, e.g. for wind turbines, etc. The dispensing assembly can, for example, be used for the dispensing of construction material, sealants, bonding material, adhesives, paints, coatings and/or protective coatings.

According to a further aspect, the present invention relates to a method of dispensing multi-component material from a cartridge using a dynamic mixer, the method comprising the steps of:

making available a respective component of a multi-component material at the inlets of the dynamic mixer;
guiding the respective component of the multi-component material towards the mixing element of the dynamic mixer via the inlets of the dynamic mixer as a flow of material;
repeatedly interrupting the flow of material when this comes into contact with one of a stator blade and a rotor blade of the dynamic mixer to bring about a rotation of the flow of material relative to the longitudinal axis for mixing the multi-component material, with the flow of material being interrupted at least six times on its passage between the inlets and the outlet.

Using such a method particularly good mixing results of the mixed multi-component material can be achieved.

### BRIEF DESCRIPTION OF DRAWINGS

The invention will be explained in more detail hereinafter with reference to the drawings.

FIG. 1 is a perspective part sectional view of a first type of dynamic mixer;

FIG. 2 is a top view of the dynamic mixer of FIG. 1;

FIG. 3 is a view of the dynamic mixer of FIG. 1 with part of the housing removed along the sectional line A:A of FIG. 2;

FIG. 4 is a sectional view of a further dynamic mixer taken along the sectional line A:A of FIG. 2;

FIG. 5 is a schematic top view of the dynamic mixer of FIG. 4 with a housing part removed;

FIG. 6 is a perspective part sectional view of a further type of dynamic mixer;

FIG. 7 is a top view of the dynamic mixer of FIG. 6;

FIG. 8 is a view of the dynamic mixer of FIG. 6 with part of a housing removed along the sectional line A:A of FIG. 7; and

FIG. 9 is a schematic view of a dispensing assembly.

### DETAILED DESCRIPTION

In the following, the same reference numerals will be used for parts having the same or equivalent function. Any statements made having regard to the direction of a component are made relative to the position shown in the drawing and can naturally vary in the actual position of application.

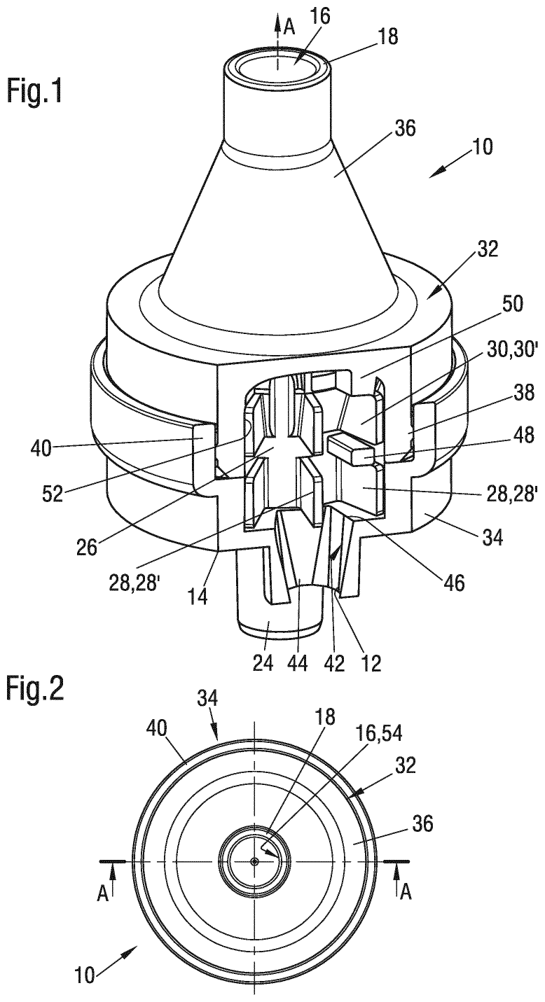

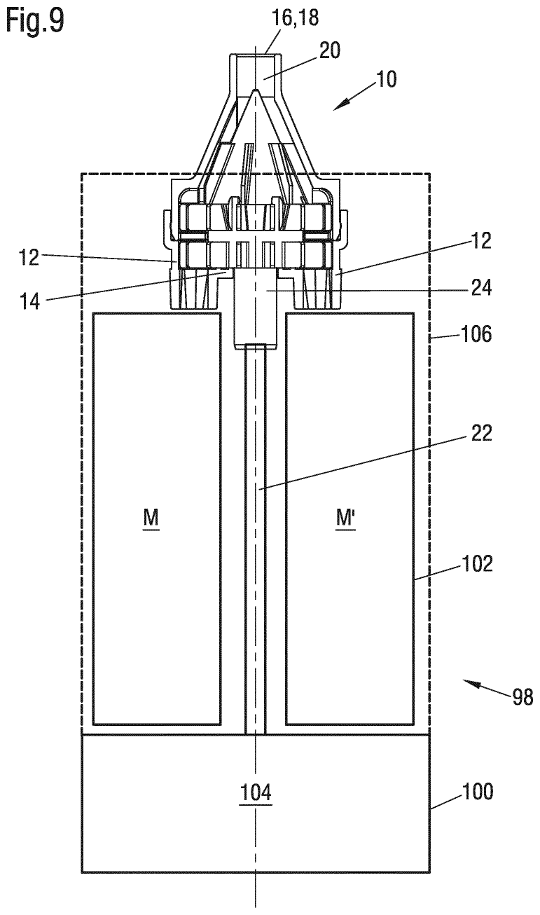

FIG. 1 shows a perspective part sectional view of a first type of dynamic mixer 10. The dynamic mixer 10 has two inlets 12 arranged at an inlet side 14 of the dynamic mixer 10. The dynamic mixer has an outlet 16 arranged at an outlet side 18 of the dynamic mixer 10. A mixing element 20 of the dynamic mixer 10 is arranged between the two inlets 12 and the outlet 16. The mixing element 20 is configured to be coupled to a drive shaft 22 (see FIG. 9) via a coupling 24 to drive the mixing element about a longitudinal axis A of the mixing element 20. The coupling 24 can either be formed in the rotor body 26 or at the rotor body 26, e.g. within a shaft extending from the rotor body 26, with the shaft being integrally formed with the rotor body 26.

The mixing element 20 comprises a rotor body 26 arranged between the inlets 12 and the outlet side 18. A first and a second row of rotor blades 28, 30 can be seen in FIG. 1 each comprising a plurality of rotor blades 28′, 30′. The respective rotor blades 28′, 30′ project radially from the rotor body 26 away from the longitudinal axis A. The first row of rotor blades 28 is arranged closer to the two inlets 12 than the second row of rotor blades 30.

The dynamic mixer 10 further comprises a housing 32 accommodating the mixing element 20. In FIG. 1 the housing 32 is formed of two parts, a base part 34 and a top part 36. The top part 36 being received in the base part by a press fit. A nose 38 of the top part 36 presses against a collar 40 of the base part 34. In an alternative way the parts can also be connected by way of a weld.

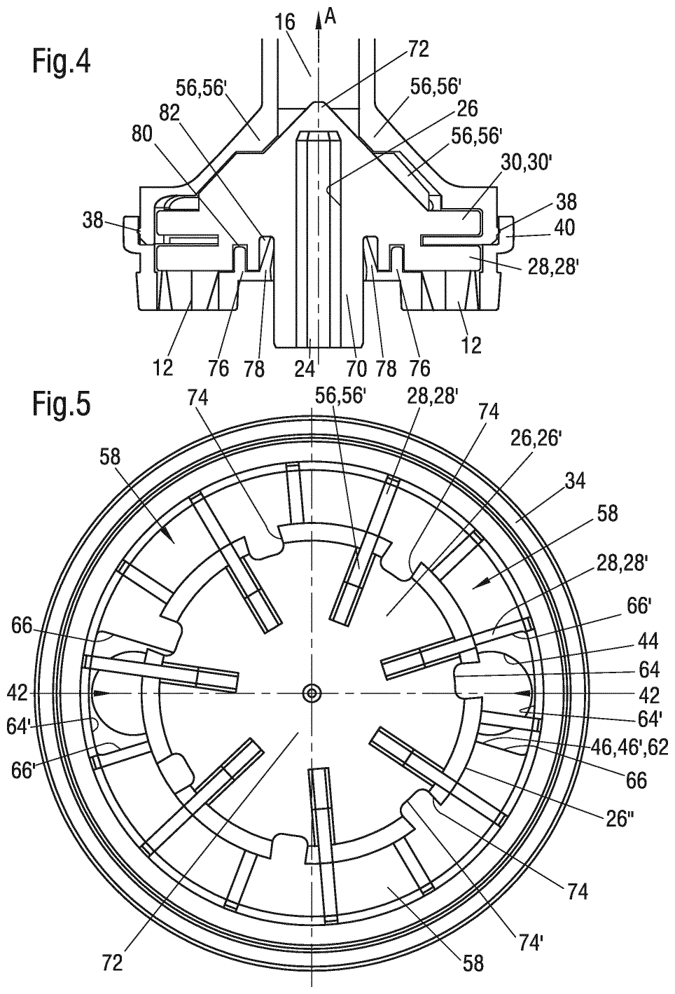

The inlets 12 of the dynamic mixer 10 are integrally formed in one piece with the base part 34. The mixing element 20 is journaled with respect to the base part 34 as indicated e.g. relative to FIG. 4.

As can also be seen in FIG. 1, the inlets 12 each comprise a passage 42 that extends between an inlet opening 44 and a mixer entry opening 46, i.e. the inlet opening 44 is arranged remote from the first row of rotor blades 28. The mixer entry opening 46 is arranged directly adjacent to the first row of rotor blades 28.

Each inlet 12 has a cross-sectional size and shape that changes between the inlet opening 44 and the mixer entry opening 46. As shown in FIG. 1 the inlet opening 44 can be formed as having a circular shape. In this connection it should be noted that also other shapes different from the circular shape are possible. The cross-sectional size of each inlet 12 increases between the inlet opening 44 and the mixer entry opening 46.

First and second stator blades 48, 50 are also visible in the cut-away part of the housing 32. The first stator blade 48 is arranged between the first and second row of rotor blades 28, 30. The first and second stator blades 48, 50 are arranged at an inner surface 52 of the housing 32.

FIG. 2 shows a top view of the dynamic mixer of FIG. 1. The outlet 16 has a circular shaped outlet opening 54 via which components mixed using the mixing element 20 of the dynamic mixer 10 exit the dynamic mixer 10.

The inlet opening 44 of each inlet 12 is arranged in parallel to the mixer entry opening 46 and to the outlet opening 54 of the outlet 16.

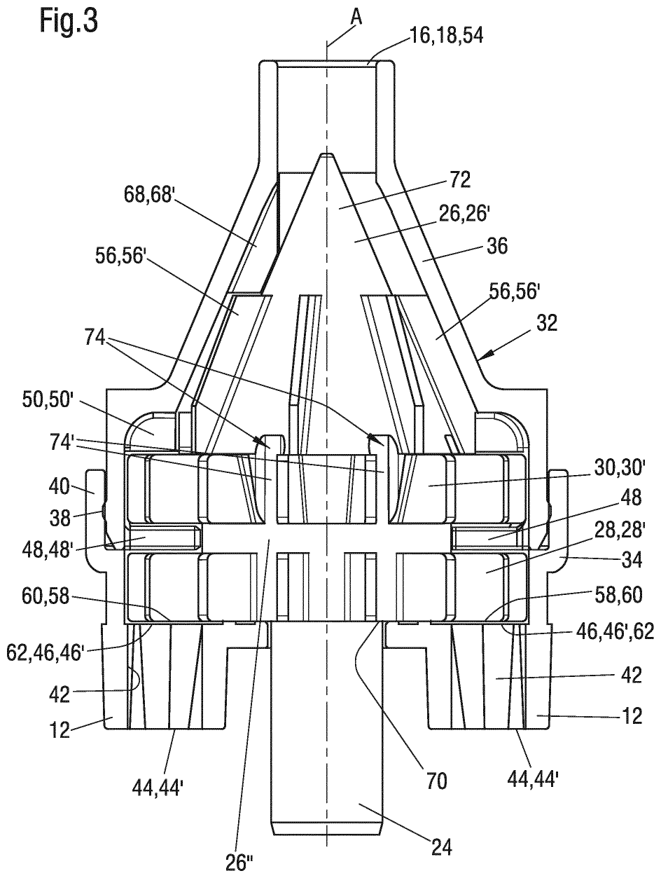

FIG. 3 shows a sectional view of the dynamic mixer of FIG. 1 taken along the sectional line A:A of FIG. 2. The rotor body 26 comprises a third row of rotor blades 56 arranged adjacent to the second row of rotor blades 30 along the longitudinal axis A of the mixing element 20. The third row of rotor blades 56 is arranged closer to the outlet 16 than the first row of rotor blades 28.

The rotor blades 56′ of the third row of rotor blades 56 each have a different axial position and outer size along the longitudinal axis A of the mixing element 20 in comparison to the rotor blades 28′ of the first row of rotor blades 28.

The rotor blades 56′ of the third row of rotor blades 56 is arranged at a conical shaped part 26′ of the rotor body 26. In the example shown the angle of the conical shaped part 26′ of the rotor body 26 relative to the longitudinal axis A is 25°. Generally speaking the angle of the conical shaped part 26′ and the longitudinal axis A can be selected in the range of 10 to 70°. The rotor body 26 reduces in diameter along the longitudinal axis A between the first row of rotor blades 28 and the outlet 16.

An area between two directly adjacent rotor blades 28′ of the first row of rotor blades 28, the rotor body 26 and the housing 32 is an open area 58 at a mixing inlet end 60. The mixer entry opening 46 is arranged directly adjacent to the open area 58 and hence to the mixing inlet end 60. The mixer entry opening 46 has a mixer inlet area 46′, with the mixer inlet area being greater than the open area 58. More specifically the mixer inlet area 46′ is less than twice the open area 58. The inlet opening 44 of each inlet 12 has an inlet area 44′ that is smaller than the mixer inlet area 46′ of the mixer entry opening 46.

In this connection it should be noted that it is preferable if the respective mixer inlet area 46′ of the mixer entry opening 46 has a size which corresponds to 1.4 to 1.6, preferably 1.5 or at least substantially 1.5, times the area of the respective inlet area 44′ of one of the inlet openings 44.

In this connection it should be further noted that it is preferable if an area of the outlet opening 54 is selected in the range of 0.5 to 1.5 times the sum of the inlet areas 44′ of each inlet opening 44 of each inlet 12.

It should further be noted that a width of the mixer entry opening 46 is selected in the range of 1.3 to 1.8, preferably 1.5 or at least substantially 1.5, times a spacing between the first blades 28′ of the first row of rotor blades 28 at the radial most outer point of the respective rotor blades 28′.

Respectively that the mixer inlet area 46′ corresponds to 1.4 to 1.6, preferably 1.5 or at least substantially 1.5, times the open area 58.

It should further be noted that depending on the type of two-component material to be mixed that the area of one of the two mixer inlet areas 46′ respectively the inlet area 44′ of one of the inlet openings 44 of the two inlets 12 can be smaller in size than the other one of the corresponding inlets in order to permit an adaptation of the dynamic mixer to high and low viscosity liquids.

In a top view (in this regard please also see FIG. 5) the mixer entry opening 46 has a shape resembling a ring shaped section 62 perpendicular to the longitudinal axis A. The ring shaped section 62 having inner and outer curved side surfaces 64, 64′ and planar side surfaces 66,66′.

A row of stator blades 48′ is arranged between the first and second rows of rotor blades 28, 30, a second row of stator blades 50′ is arranged between the second and third rows of rotor blades 30, 56 and a third row of stator blades 68 is arranged between the third row of rotor blades 56 and the outlet 16.

The first row of rotor blades 28 comprises more rotor blades 28′ than the third row of rotor blades 56. It is preferred if less rotor blades 56′, in particular half as many rotor blades 56′, are provided in the third row of rotor blades 56 as rotor blades 28′ are provided in the first row of rotor blades 28. As also shown in FIGS. 3 and 5 as many rotor blades 30′ are provided in the second row of rotor blades 30 as are provided in the first row of rotor blades 28.

The first and second row of rotor blades 28, 30 comprise rotor blades 28′, 30′ having a like shape, in particular a rectangular shape, and size, i.e. a height of 6 mm measured in parallel to the longitudinal axis A. In this connection it should be noted that the height of the rotor blades 28′ should be at least 5 mm and is preferably selected in the range of 5 to 10 mm.

The height of the stator blades 48 of the first row of stator blades 48′ is less than the height of the rotor blades 28′, 30′ and is especially less than half the height of the rotor blades 28′, 30′ and is generally selected in the range of 20% to 50% of the height of the rotor blades 28′, 30′.

A height of the rotor blades 56′ of the third row of rotor blades 56 is greater than a height of the rotor blades 28′, 30′ of the first or second row of rotor blades 28, 30. Preferably the height of the rotor blades 56′ is selected in the range of 8 to 20 mm, especially of 10 to 12 mm.

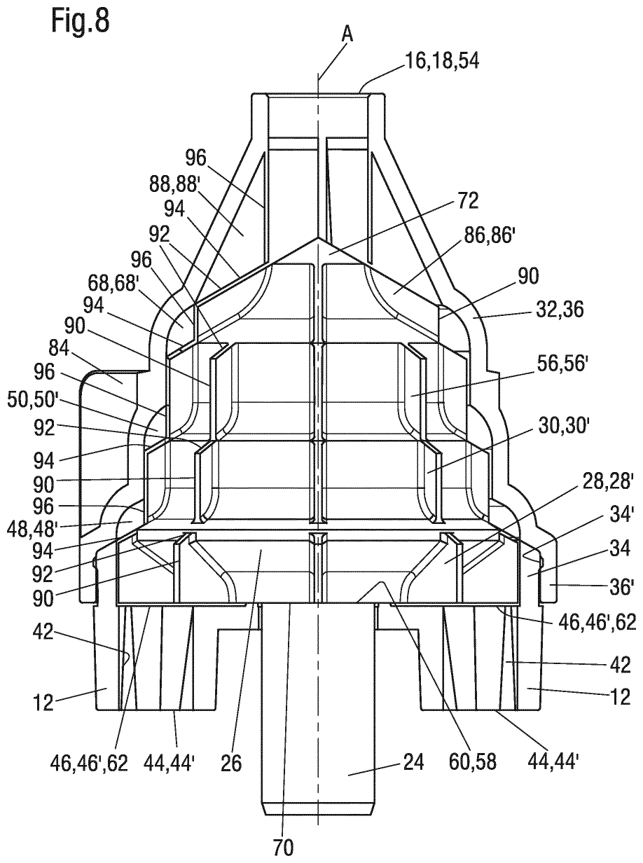

The rotor blades 56′ of the third row of rotor blades 56 have a wedge shaped design. The design of the rotor blades 56′ of the third row of rotor blades 56 can deviate from the wedge shaped design as shown e.g. in connection with FIG. 8.

It should be noted in this connection that an axial gap along the longitudinal axis A between directly adjacent rotor blades 28′, 30′, 56′ and stator blades 48, 50, 68′ is generally selected in the range of 0.01 to 0.4 mm, and preferably is selected as 0.2 mm as shown in FIGS. 3, 4 and 8.

It should further be noted that a radial gap between the inner surface 52 of the housing 32 and one of the rotor blades 28′, 30′, 56′ and respectively between one of the stator blades 48, 50, 68′ and the rotor body 26 is selected in the range of 0.01 to 0.4 mm, and preferably is selected as 0.2 mm as shown in FIGS. 3, 4 and 8.

In this connection it should be noted that each of the rotor blades 28′, 30′, 50′ can have a wedge shaped outer contour, with the wedge becoming smaller as the wedge extends away from the longitudinal axis A.

Similarly the stator blades 48′, 50′, 68′ that project radially between the rotor body 26 and the housing 32 also have a wedge like outer shape, with the wedge becoming smaller as the wedge extends away from the longitudinal axis A.

It is also possible that the first row of stator blades 48′ has a smaller outer circumference in comparison to the second row of stator blades 50′.

Directly adjoining the conical shaped part 26′ the rotor body 26 also has a cylindrical shaped part 26″ at its front end 70, with the first and second row of rotor blades 28, 30 projecting from the cylindrical shaped part 26″.

A passage 74 extends between two directly adjacent rotor blades 30′ of the second row of rotor blades 30 and two directly adjacent rotor blades 56′ of the third row of rotor blades 56 between the conical shaped part 26′ and the cylindrical shaped part 26″.

A base 74′ of the respective passage 74 extends in parallel with the longitudinal axis A and as can be seen in FIG. 5 the passage 74 has a rectangular cross-section in parallel with the longitudinal axis A. The passages 74 are provided in order to ensure a reliable assembly of the dynamic mixer 10.

FIG. 4 shows a sectional view of a further dynamic mixer 10 similar to the view of FIG. 3. In contrast to the dynamic mixer 10 shown in FIG. 3, the angle of the conical shaped part 26′ of the rotor body 26 relative to the longitudinal axis A is 45°.

Like the rotor body 26 of the dynamic mixer 10 shown in FIGS. 1 to 3, the rotor body 26 of FIG. 4 has a front end 70 in the region of the mixer entry opening 46 and a rear end 72 in the region of the outlet 16. The rotor body 26 has the conical outer shaped part 26′ at the rear end 72, with the third row of rotor blades 56 projecting from the conical outer shaped part 26′.

The dynamic mixers 10 shown in FIGS. 3 and 5 each comprise three rows of rotor blades 28, 30, 56, with the first and second row of rotor blades 28, 30 comprising the same number of rotor blades 28′, 30′ and the third row of rotor blades 56 comprising less rotor blades 56′ than either of the first and second rows of rotor blades 28, 30.

In this connection it should be noted that generally speaking the first and second rows of rotor blades 28, 30 can each comprise between 10 and 20, preferably between 12 and 16, especially 14 rotor blades 28′, 30′ and the third row of rotor blades 56 can comprise between 5 and 9, preferably between 6 and 8 and especially 7, rotor blades 56′.

The rotor body 26 is journaled at the base part 34 of the housing 32 via two annular projections 76, 78 respectively engaging ring-shaped grooves 80, 82 present in the rotor body 26. The first annular projection 76 is generally rectangular in shape and projects into the first ring-shaped groove 80. The second annular projection 78 tapers towards the longitudinal axis A and thereby engages a sidewall of the second ring-shaped groove 80. In this way a seal is formed between the rotor body 26 and the base part 34 of the housing 32 in order to avoid multi-component material from exiting the dynamic mixer 10 in the region of the coupling 24.

FIG. 5 shows a schematic top view of the dynamic mixer of FIG. 4 with the top part 36 of the housing 32 removed. As can clearly be seen each of the mixer entry openings 46 has a shape resembling the ring shaped section 62 perpendicular to the longitudinal axis A. Moreover, the area of the mixer entry openings 46 is larger than the open area 58 between directly adjacent rotor blades 28′ of the first row of rotor blades 28, the rotor body 26 and the housing 32.

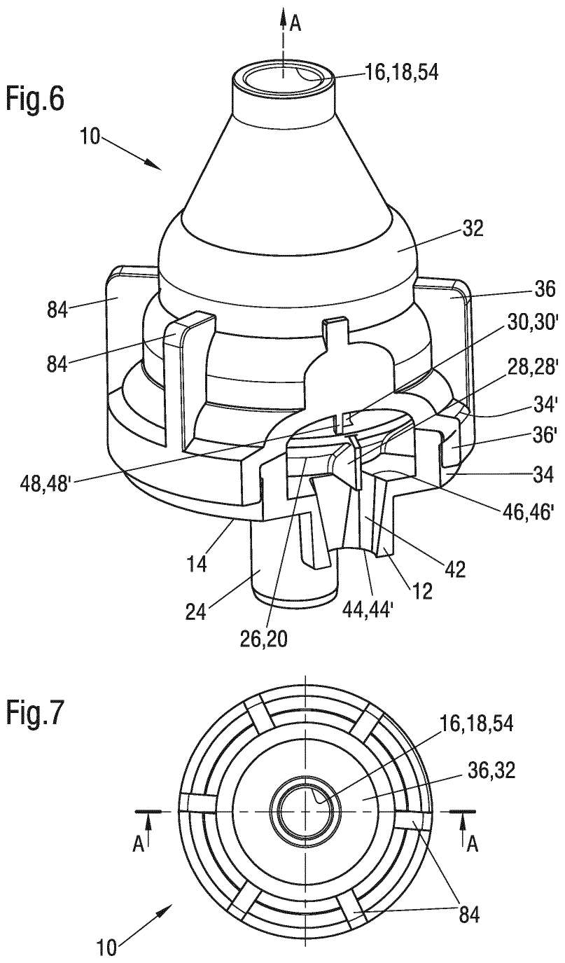

FIG. 6 shows a perspective part sectional view of a further type of dynamic mixer 10. The design differs with regard to the design shown in FIGS. 1 to 5. The differences are due to the different design of mixing element 20 which will be discussed in the following and due to the difference in design of the housing 32.

The housing 32 is a two-part housing comprising the top part 36 and the base part 34. A collar 36′ of the top part 36 engages over a ring-shaped projection 34″ of the base part 34 and engages a nose 34′ of the base part 34 to bring about a seal between the top and bottom parts 36, 34 of the housing 32.

Moreover, the housing 32 also comprises wings 84. The wings 84 are provided to stiffen the housing 32 from the outside in order to maintain the seal between the top and bottom parts 36, 34 of the housing 32.

FIG. 7 shows a top view of the dynamic mixer of FIG. 6. One can see that six wings 84 are provided. The designs of FIGS. 1 to 5 do not show wings 84, it should however be noted that also the designs of FIGS. 1 to 5 can have wings 84 provided on the outside of the top part 36 of the housing 32. Generally speaking between 3 and 10 such wings 84 can be provided.

FIG. 8 shows a sectional view of the dynamic mixer of FIG. 6 taken along the sectional line A:A of FIG. 7. The mixing element 20 comprises four rows of rotor blades 28, 30, 56, 86 arranged one after another and projecting radially from the rotor body 26 away from the longitudinal axis A between the rotor body 26 and the housing 32 accommodating the mixing element 20 of the dynamic mixer 10.

The rotor body 26 decreases in size from the inlets 12 towards the outlet 16 at the position of each of the rotor blades 28′, 30′, 56′, 86′ of each of the four rows of rotor blades 28, 30, 56, 86. Each row of rotor blades 28, 30, 56, 86 is thus arranged at a different axial position along the longitudinal axis A of the mixing element 20. Four rows of stator blades 48′, 50′, 68, 88 are arranged at the inner surface 52 of the housing 32. The four rows of stator blades 48′, 50′, 68, 88 are arranged in alternating arrangement with the four rows of rotor blades 28, 30, 56, 86. The alternating arrangement starting at the mixer entry opening 46 is the first row of rotor blades 28 followed by the first row of stator blades 48′, followed by the second row of rotor blades 30 followed by the second row of stator blades 50′ followed by the third row of rotor blades 56, followed by the third row of stator blades 68, followed by the fourth row of rotor blades 86, followed by the fourth row of stator blades 88.

It should be noted in this connection that the fourth row of rotor blades 86 comprises less rotor blades 86′ than either of the first, second or third row of rotor blades, 28, 30, 56. It can be the case that half as many rotor blades 86′ are provided as in the first, second or third row of rotor blades, 28, 30, 56.

An outer diameter of the rotor body 26 reduces in size between each of the four rows of rotor blades 28, 30, 56, 86, such that the rotor body 26 decreases in size between the inlets 12 and the outlet 16.

Each of the rotor blades 28′, 30′, 56′, 86′ of each of the four rows of rotor blades 28, 30, 56, 86 comprises a vertical wall 90 that extends in parallel with the longitudinal axis A and a top wall 92 that extends inclined with the vertical wall 90. The angle of inclination between the top wall 92 and the vertical wall 90 can generally be selected in the range of 10 to 80° and in the example shown in FIG. 8 is 30°.

Each stator blade 48, 50, 68′, 88′ of the four rows of stator blades 48′, 50′, 68, 88 has a bottom wall 94 that extends in parallel with the top wall 92 and a side wall 96 that extends in parallel with the longitudinal axis A. The angle of inclination between the bottom wall 94 and the side wall 96 can generally be selected in the range of 100 to 170° and in the example shown in FIG. 8 is 120°.

The respective axial gap thus extends between the side walls 96 and the vertical walls 90. The respective radial gap thus extends between the top walls 92 and the bottom walls 94.

Each of the inlets 12 is formed by the passage 42. The respective inlet opening 44 and the mixer entry opening 46 are arranged in parallel to one another and to the outlet opening 54 of the outlet 16.

In all of the designs of the dynamic mixer 10 shown it should be noted that between three and ten, preferably seven, stator blades 48, 50, 68′, 88′ can be arranged in each row of stator blades 48′, 50′, 68, 88.

It should further be noted that less stator blades 48, 50, 68′, 88′ are provided than rotor blades 28′, 30′, 56′, 86′.

FIG. 9 shows a schematic view of a dispensing assembly 98. The dispensing assembly comprises a dispenser 100, a cartridge 102, filed with a multi-component material M, M′, received in the dispenser 100 and a dynamic mixer 10. The dispenser 100 comprises the drive shaft 22 that can be coupled to the coupling 24 of the mixing element 20 of the dynamic mixer 10 to drive the mixing element 20 about the longitudinal axis A of the mixing element 20 on dispensing the multi-component material M, M′ from the cartridge. The dispenser 100 further comprises a motor 104 to drive the drive shaft 22 and a receptacle 106 configured to receive the multi-component cartridge 102.

Upon dispensing the multi-component material M, M′ from the cartridge two pistons (not shown) are moved within the cartridge towards the dynamic mixer 10 via two plungers (also not shown) of the dispensing assembly 98. In this way a respective component of the multi-component material M, M′ is made available at one of the two inlets 12 of the dynamic mixer 10. The respective component of the multi-component material M, M′ is guided towards the mixing element 20 of the dynamic mixer 10 via the inlets 12 of the dynamic mixer 10 as a flow of material (not shown).

The mixing element 20 is rotated while the flow of material is guided through the dynamic mixer 10 in order to constantly move slices of the flow of material of the respective components of the multi-component material M, M′ not only in the direction of the outlet 16, but also in a radial direction, so that the different slices of components of the multi-component material M, M′ come into contact with one another and are thereby mixed prior to exiting the outlet 16. When the flow of material comes into contact with one of a stator blade 48, 50 and a rotor blade 28′, 30′, 56′ of the dynamic mixer 10 the flow of material is repeatedly interrupted to bring about the rotation of the flow of material relative to the longitudinal axis A for mixing the multi-component material M, M′, with the flow of material being interrupted six, eight or more times on its passage between the inlets 12 and the outlet 16.

While the respective components are guided through the inlets, a diameter of the flow of material is expanded in the direction towards the mixing element 20 of the dynamic mixer 10 between the inlets 12 and the mixing element 20, in order to reduce the flow speed of the multi-component material M, M′ for an improvement of the mixing quality.

If passages 74 are provided between different rows of rotor blades 30, 56, these can further improve the mixing results of the mixed multi-component material M, M′ as the flow of material can be interrupted at further dedicated positions introducing further vortices to bring about a momentary stop of the flow of the multi-component material M, M′ which ensures an improved through mixing of the multi-component material M, M′.

The dynamic mixers 10 taught in the foregoing can be formed e.g. in an injection molding process or using a 3D printer from a plastic material. This means that the housing 32 and the mixing element 20 are each formed from a plastic material.

The material of the mixing element 20 can be selected harder than a material of the housing 32. In this connection it should be noted that the base part 34 and the top part 36 of the housing can be formed from the same material or a different material.

A material of the mixing element 20 and hence that of the rotor blades 28′, 30′, 56′, 86′ of the mixing element 20 and/or a material of the housing 32 and hence that of the stator blades 48, 50, 68′, 88′ can be selected having a SHORE D hardness in the range of 50 to 90, preferred materials for these components are Polypropylene (PP) and Polyoxymethylene (POM) and hence the preferred range of the SHORE D hardness is selected in the range of 60 to 88.

1. A dynamic mixer comprising:
at least two inlets arranged at an inlet side of the dynamic mixer;
an outlet arranged at an outlet side of the dynamic mixer; and
a mixing element configured to be coupled via a coupling to a drive shaft to drive the mixing element about a longitudinal axis of the mixing element, the mixing element comprising a rotor body and at least three rows of rotor blades arranged one after another and projecting radially from the rotor body away from the longitudinal axis between the rotor body and a housing accommodating the dynamic mixer, the rotor body decreasing in size from the inlets towards the outlet at least over 30% of a length of the rotor body, a first row of at least three rows of rotor blades arranged at a different axial position along the longitudinal axis of the mixing element in comparison to the third row of the at least three rows of rotor blades at least three rows of stator blades are provided with a respective row of the at least three rows of stator blades being arranged in alternating arrangement with the at least three rows of rotor blades each of the at least two inlets formed by a passage having an inlet opening and a mixer entry opening formed adjacent to the first row of the at least three rows of rotor blades, a respective inlet opening for the at least two inlets arranged in parallel to the mixer entry opening, and in parallel to an outlet opening of the outlet.

2. The dynamic mixer in accordance with claim 1, wherein at least one row of the at least three rows of rotor blades is arranged at a part of the rotor body decreasing in size.

3. The dynamic mixer in accordance with claim 1, wherein the rotor body comprises a conical shaped part arranged at a rear end of the mixing element, and the third row of the at least three rows of rotor blades is arranged projecting from the conical shaped part.

4. The dynamic mixer in accordance with claim 1, wherein the rotor body comprises a cylindrical shaped part at a front end, with the first row and a second row of the at least three rows of rotor blades projecting from the cylindrical shaped part (26″).

5. The dynamic mixer in accordance with claim 3,
wherein the at least three rows of rotor blades includes only three rows of rotor blades, with the first row and a second row of rotor blades of the three rows of rotor blades comprising a same number of rotor blades and the third row of rotor blades comprising fewer rotor blades than either of the first and second rows of rotor blades.

6. The dynamic mixer in accordance with claim 5, wherein the first and second rows of rotor blades each comprise between 10 and 20 rotor blades, or the third row of rotor blades comprises between 5 and 9 rotor blades.

7. The dynamic mixer in accordance with claim 1, wherein a number of rows of the at least three row of stator blades is equal to a number of rows as the at least three rows of rotor blades, with the alternating arrangement starting at the at least two inlets starting with the first row of the at least three rows of rotor blades and with a final row of the at least three rows of stator blades being arranged closer to the outlet than a final row of the at least three rows of rotor blades, or
between three and ten stator blades are arranged in each row of stator blades, or
wherein a number of stator blades in the at least three row of stator blades is less than a number of the rotor blades in the at least three row of rotor blades or a number of the stator blades in the at least three row of stator blades is equal to a number of the rotor blades in the at least three row of rotor blades, or
the coupling is formed at or in a part of the rotor body.

8. The dynamic mixer in accordance with claim 1, wherein the at least three rows of rotor blades includes four rows of rotor blades with each row of rotor blades being arranged at a different axial position along the longitudinal axis of the mixing element in comparison to a remaining row of rotor blades.

9. The dynamic mixer in accordance with claim 8, wherein two or three rows of the four rows of rotor blades comprises a same number of rotor blades.

10. The dynamic mixer in accordance with claim 1, wherein an axial gap along the longitudinal axis between directly adjacent rotor blades of at least three rows of rotor blades and stator blades of at least three rows of stator blades is selected in the range of 0.01 to 0.4 mm.

11. The dynamic mixer in accordance with claim 1, wherein a radial gap between an inner surface of the housing and one of the rotor blades in the at least three rows of rotor blades and between one of the stator blades and the rotor body is selected in the range of 0.01 to 0.4 mm.

12. The dynamic mixer in accordance with claim 1, wherein a cross-sectional size of each of the at least two inlet increases between the inlet opening and the mixer entry opening.

13. The dynamic mixer in accordance with claim 1, wherein an area between two directly adjacent rotor blades of the first row of the at least three rows of rotor blades, the rotor body and the housing is an open area, and the mixer entry opening has a mixer inlet area, with the mixer inlet area being greater than the open area.

14. A dispensing assembly comprising:
a dispenser;
a cartridge; for multi-component material configured to be received in the dispenser; and
the dynamic mixer in accordance with claim 1, the dispenser comprising the drive shaft to be coupled to the mixing element of the dynamic mixer to drive the mixing element about the longitudinal axis of the mixing element upon dispensing the multi-component material from the cartridge.

15. A method of dispensing multi-component material from the cartridge using the dynamic mixer in accordance with claim 1, the method comprising:
making available a respective component of a multi-component material at the inlets of the dynamic mixer;
guiding the respective component of the multi-component material towards the mixing element of the dynamic mixer via the inlets of the dynamic mixer as a flow of material;
repeatedly interrupting the flow of material when the flow of material comes into contact with one of a stator blade of the at least three rows of stator blades and a rotor blade of the at least three rows of rotor blades of the dynamic mixer to bring about a rotation of the flow of material relative to the longitudinal axis for mixing the multi-component material, with the flow of material being interrupted at least six times upon passage between the at least two inlets and the outlet.

16. The dynamic mixer in accordance with claim 1, wherein the mixer entry opening is formed directly adjacent to the first row of the at least three rows of rotor blades.

17. The dynamic mixer in accordance with claim 7, wherein between six and eight stator blades are arranged in each row of stator blades.

18. The dynamic mixer in accordance with claim 1, wherein an axial gap along the longitudinal axis between directly adjacent rotor blades of at least three rows of rotor blades and stator blades of at least three rows of stator blades is 0.2 mm.

19. The dynamic mixer in accordance with claim 1, wherein a cross-sectional size of each of the at least two inlet continuously increases between the inlet opening and the mixer entry opening.

20. The dynamic mixer in accordance with claim 1, wherein an area between two directly adjacent rotor blades of the first row of the at least three rows of rotor blades, the rotor body and the housing is an open area, and the mixer entry opening has a mixer inlet area, with the mixer inlet area being larger than an inlet area of the inlet opening.
